(19) United States
(12) Patent Application Publication
(10) Pub. No.: US 2012/0214127 A1
(43) Pub. Date: Aug. 23, 2012

(54) DENTAL IMPLANT SYSTEM WITH SEPARABLE DRIVE AND METHOD

(75) Inventors: Susan J. Drapeau, Cordova, TN (US); Kelly Brook Emerton, Memphis, TN (US); Daniel Andrew Shimko, Germantown, TN (US)

(73) Assignee: WARSAW ORTHOPEDIC, INC., Warsaw, IN (US)

(21) Appl. No.: 13/031,673

(22) Filed: Feb. 22, 2011

(51) Int. Cl. A61C 8/00

(52) U.S. Cl. 433/141; 433/173

(57) ABSTRACT

A dental implant system includes an abutment including a first portion configured for disposal within an inner cavity of a dental implant and defining an outer surface configured for fixation with an inner surface of the dental implant. The abutment includes a second portion having a drive configured to separate from the abutment at a predetermined force. Methods of use are also disclosed.

### TECHNICAL FIELD

The present disclosure generally relates to medical devices for the treatment of periodontal disorders, and more particularly to a dental implant system that includes a drive configured to separate, for example, by mechanical failure at a predetermined force to facilitate fixation of system components and prevent undesired securement of system components within tissue.

### BACKGROUND

Implants are widely used in dental surgery for restoration of the jaw anatomy in various applications including, for example, human and veterinary. Implants can be employed to anchor a dental prosthesis, such as, for example, an artificial tooth to a jawbone of a patient. Dental implants can be secured in the jawbone by press/friction fit, tapping, suturing, adhesive and/or threaded fixation. For example, the implant may include a threaded shaft that fixes with tissue and an abutment to facilitate securement of the implant with the dental prosthesis.

In some cases, however, the dental implant and/or components thereof may be secured at an undesirable level of torque such that overtightening occurs. A practitioner may also undertighten the dental implant components in an effort to avoid over torque. Such drawbacks can result in incompatibility and other implant failure, which can lead to bacterial invasion, loosening, improper implantation and/or tissue damage. This disclosure describes an improvement over these prior art technologies.

### SUMMARY OF THE INVENTION

Accordingly, an implant system and method is provided for treating periodontal disorders. It is contemplated that the implant system includes a drive configured to separate, for example, by mechanical failure at a predetermined force to facilitate fixation of system components and prevent undesired securement of system components within tissue. It is further contemplated that the implant system includes a break away drive that facilitates fixation of an abutment at a predetermined torque with an implant disposed within jawbone.

In one particular embodiment, in accordance with the principles of the present disclosure, a dental implant system is provided. The dental implant system includes an abutment including a first portion configured for disposal within an inner cavity of a dental implant and defining an outer surface configured for fixation with an inner surface of the dental implant. The abutment includes a second portion having a drive configured to separate from the abutment at a predetermined force.

In one embodiment, the dental implant system includes a dental implant positionable within a body cavity disposed below an outer surface of a jaw. The dental implant includes an inner surface that defines an inner cavity and an outer surface configured for fixation with the body cavity. An abutment includes a shaft defining an outer surface configured for disposal within the inner cavity of the dental implant and configured for fixation with the inner surface of the dental implant. The abutment including a base and a drive. The drive includes a first end connected with the base via a reduced diameter portion configured to fracture and separate from the base at a predetermined torque.

In one embodiment, a method for treating a jawbone is provided. The method includes the steps of: providing an abutment including a first portion defining an outer surface configured for disposal within an inner cavity of a dental implant disposed within a body cavity of the jawbone and configured for fixation with an inner surface of the dental implant, the abutment further including a second portion having a drive configured to separate from the abutment at a predetermined force; inserting the first portion of the abutment with the dental implant; and engaging the drive with a force to fix the abutment with the dental implant to the predetermined force such that the drive separates from the abutment at the predetermined force.

### BRIEF DESCRIPTION OF THE DRAWINGS

The present disclosure will become more readily apparent from the specific description accompanied by the following drawings, in which:

FIG. 1 is a perspective view of one particular embodiment of a dental implant system with parts separated in accordance with the principles of the present disclosure;

FIG. 2 is a side view of the dental implant system shown in FIG. 1;

FIG. 3 is an enlarged side view of an abutment of the dental implant system shown in FIG. 2;

FIG. 4 is a side view in part cross section of one embodiment of the dental implant system shown in FIG. 2 within a jaw cavity; and

FIG. 5 is a side view in part cross section of one embodiment of the dental implant system shown in FIG. 2 within a jaw cavity.

### DETAILED DESCRIPTION OF THE INVENTION

The exemplary embodiments of the dental implant system and related methods of use disclosed are discussed in terms of medical devices for the treatment of periodontal disorders, and more particularly, in terms of a dental implant system that includes a drive configured to separate, for example, by mechanical failure at a predetermined force to facilitate fixation of system components and prevent undesired securement of system components within tissue. It is envisioned that the dental implant system includes a break away drive that facilitates fixation of an abutment at a predetermined torque with an implant disposed within jawbone. It is contemplated that the dental implant system allows a medical practitioner to mount an abutment with a dental implant at a maximum torque such that a break away element automatically breaks off from a component of the dental implant system, for example, the abutment, at a desired torque. It is further contemplated that the abutment can be fixed with a dental implant at a desired torque without using a torque measurement tool. It is envisioned that the break away element is adaptable for use with various implant components, implants and/or implant systems. The dental implant system may be configured as a kit or system that includes one or a plurality of abutments, implants and/or prosthetic devices, which may be variously sized and adapted.

It is envisioned that the present disclosure may be employed to treat periodontal disorders such as, for example, peri-implantitis, chronic, aggressive and necrotizing periodontitis, gingivitis and other periodontal diseases. It is contemplated that the present disclosure may be employed with other osteal and bone related applications, including those associated with diagnostics and therapeutics. The system and methods of the present disclosure may also be used on animals, bone models and other non-living substrates, such as, for example, in training, testing and demonstration.

The present invention may be understood more readily by reference to the following detailed description of the invention taken in connection with the accompanying drawing figures, which form a part of this disclosure. It is to be understood that this invention is not limited to the specific devices, methods, conditions or parameters described and/or shown herein, and that the terminology used herein is for the purpose of describing particular embodiments by way of example only and is not intended to be limiting of the claimed invention. Also, as used in the specification and including the appended claims, the singular forms “a,” “an,” and “the” include the plural, and reference to a particular numerical value includes at least that particular value, unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. It is also understood that all spatial references, such as, for example, horizontal, vertical, top, upper, lower, bottom, left and right, are for illustrative purposes only and can be varied within the scope of the disclosure. For example, the references “superior” and “inferior” are relative and used only in the context to the other, and are not necessarily “upper” and “lower”.

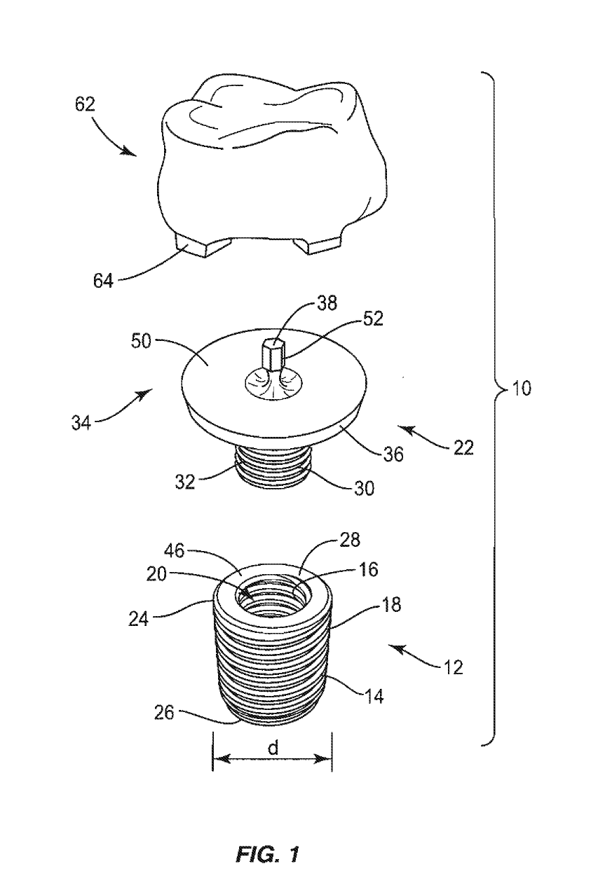

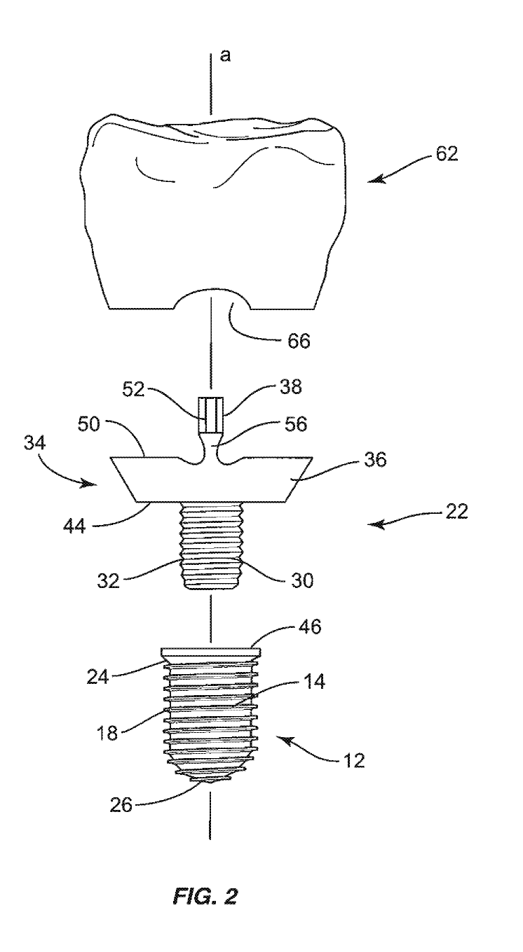

The following discussion includes a description of a dental implant system and related methods of employing the dental implant system in accordance with the principles of the present disclosure. Alternate embodiments are also disclosed. Reference will now be made in detail to the exemplary embodiments of the present disclosure, which are illustrated in the accompanying figures. Turning now to FIGS. 1-3, there is illustrated components of a dental implant system 10 in accordance with the principles of the present disclosure.

The components of dental implant system 10 are fabricated from materials suitable for medical applications, including metals, polymers, ceramics, biocompatible materials and/or their composites, depending on the particular application and/or preference of a medical practitioner. For example, the components of dental implant system 10, individually or collectively, can be fabricated from materials such as stainless steel, titanium, thermoplastics such as polyaryletherketone (PAEK) including polyetheretherketone (PEEK), polyetherketoneketone (PEKK) and polyetherketone (PEK), carbon-PEEK composites, PEEK-BaSO₄ polymeric rubbers, biocompatible materials such as polymers including plastics, metals, ceramics and composites thereof, rigid polymers including polyphenylene, polyamide, polyimide, polyetherimide, polyethylene, epoxy, and various components of the implant system, may have material composites, including the above materials, to achieve various desired characteristics such as strength, rigidity, elasticity, compliance, biomechanical performance, durability and radiolucency or imaging preference.

Dental implant system 10 is configured for treating periodontal disorders such as those described herein. Such treatment can be employed to restore jaw anatomy through the use of dental prosthetics. The components of dental implant system 10 are configured to be implanted within a jaw to secure and/or fasten system components at a desired force and/or torque without using a force and/or torque measurement tool. For example, an abutment can be mounted with a previously implanted dental implant such that a break away element of the abutment automatically breaks off at a desired torque to facilitate fixation of system components and prevent undesired securement of system components within tissue.

Dental implant system 10 includes a dental implant 12 configured for disposal within a body cavity, such as, for example, a cavity in a jaw of a patient. It is contemplated that the body cavity can be defined by tissues of the jaw, which include bone, cartilage or other tissues of the upper and lower jaw, gingiva, mandible and/or maxilla. Dental implant 12 is implantable within the jaw in a procedure and the body cavity of the jaw is disposed about dental implant 12. Dental implant 12 has an elongated body 14 that includes an inner surface 16 and an outer surface 18. Inner surface 16 defines an inner cavity 20 of body 14 that is configured to receive an abutment member 22. In use, dental implant 12 is embedded within the body cavity of the jaw in a prior implant procedure and abutment member 22 is mounted with elongated body 14 in a subsequent procedure, as described below. It is contemplated that dental implant 12 is embedded within the body cavity of the jaw and abutment member 22 can be mounted with elongated body 14 in the same procedure. It is further contemplated that abutment member 22 can be mounted with elongated body 14 in a separate, single, simultaneous or concurrent procedure.

Inner cavity 20 has a cylindrical cross section configuration and extends from a first end 24 to a second end 26 of body 14. Inner cavity 20 has a uniform cross section and diameter d extends from first end 24, which tapers and gradually decreases adjacent second end 26. It is contemplated that diameter d may be in a range of approximately 0.2 millimeters (mm) to 25.0 mm. It is further contemplated that cavity 20 may have a uniform diameter along the entire length of body 114, or have a uniformly increasing or decreasing diameter extending from first end 24 to second end 26.

Inner cavity 20 is disposed below a gum line, which may include gingival tissue and/or exposed bone, of a jaw and in bone. It is envisioned that all or only a portion of inner cavity 20 may be disposed below the gum line and/or bone. It is further envisioned that the cross section of inner cavity 20 may have various configurations such as, for example, rectangular, oval, parabolic, polygonal, dogbone, toroidal, segmented and may include undulating walls. It is contemplated that inner surface 16 may include inserts, barriers, screens, mesh and/or sponges according to the requirements of a particular application.

Inner surface 16 includes a threaded surface that matingly engages abutment 22 for fixation of abutment 22 with dental implant 12. Outer surface 18 includes a threaded surface that matingly engages with tissue of a body cavity for implantation and fixation of dental implant 12 with the tissue. Inner surface 16 and outer surface 18 define a circumferential wall 28 that defines a perimeter of body 14.

Inner surface 16 and/or outer surface 18 may be variously configured such that all or only a portion thereof is threaded, non-threaded, smooth, arcuate, undulating and/or textured. It is envisioned that inner surface 16 and/or outer surface 18 may include engagement elements that facilitate fixation including barbs, spikes, detents and/or openings. It is further envisioned that a portion of outer surface 18 may be freely exposed to an oral cavity and not engaging tissue.

Circumferential wall 28 has a uniform thickness t disposed about inner cavity 20. Thickness t increases to a closed end of body 14 adjacent second end 16. It is contemplated that thickness t may be in a range of approximately 0.05 mm to 5.00 mm. It is further contemplated that the cross section of wall 28 may be variously configured such as, for example, undulating, offset, staggered, non-continuous and/or cone shaped. It is envisioned that wall 28 may include perforations, mesh, texturing and/or openings, as alternatively described.

Dental implant system 10 may include bone growth promoting material (shown, for example, in FIG. 5), which may be disposed, packed or layered within, on or about the components and/or surfaces of dental implant system 10 and may be disposed with openings found therein. The bone growth promoting material, such as, for example, bone graft, is configured for disposal within, about and/or adjacent the body cavity.

It is envisioned that the bone graft is a particulate material, which may include an osteoconductive material such as hydroxyapatite and/or an osteoinductive agent such as a bone morphogenic protein (BMP) or demineralized bone matrix to enhance bony fixation of dental implant 12 with the treated jaw area.

It is contemplated that the bone graft may include therapeutic polynucleotides or polypeptides, which can be packed or otherwise disposed in the body cavity of the jaw. It is further contemplated that the bone graft may include biocompatible materials, such as, for example, biocompatible metals and/or rigid polymers, such as, titanium elements, metal powders of titanium or titanium compositions, sterile bone materials, such as allograft or xenograft materials, synthetic bone materials such as coral and calcium compositions, such as hydroxyapatite, calcium phosphate and calcium sulfite, biologically active agents, for example, gradual release compositions such as by blending in a bioresorbable polymer that releases the biologically active agent or agents in an appropriate time dependent fashion as the polymer degrades within the patient. Suitable biologically active agents include, for example, BMP, Growth and Differentiation Factors proteins (GDF) and cytokines.

Dental implant system 10 includes abutment 22 that is configured to provide support and structure to extend dental implant 12 to and/or above the gum line of a patient for connecting with a dental prosthetic, described below. Abutment 22 includes a first threaded portion, such as, for example, a threaded shaft 30 that defines an outer surface 32 configured for disposal within inner cavity 20 of dental implant 12. Shaft 30 has a cylindrical cross section configuration and extends from a first end 34 to a second end 36 of abutment 22.

Shaft 30 is configured for disposal entirely below a gum line of a jaw within inner cavity 20. Shaft 30 is configured for threaded fixation with inner surface 16 of dental implant 12 such that abutment 22 is fixedly mounted with dental implant 12. It is envisioned that all or only a portion of shaft 30 may be disposed below the gum line. It is further envisioned that the cross section of shaft 30 may have various configurations such as, for example, those alternatives described herein. It is contemplated that shaft 30 may have alternate surface configurations, for alternative fixation configurations with dental implant 12, such as, for example, smooth, textured for friction fit, oversized for pressure fit, spring biased detent/groove and/or slotted for pin connection to facilitate fixation with a correspondingly configured cavity 20 of dental implant 12.

Abutment 22 includes a second portion 34 that includes a base 36 and a drive 38. Base 36 is disposed between shaft 30 and drive 38, and extends from a first end 40 to a second end 42 thereof. Base 36 has a diameter d₁, which is tapered and gradually decreases from second end 42 to first end 40. It is contemplated that base 36 may have a uniform diameter along the entire length of base 36, or have a uniformly increasing diameter from second end 42 to first end 40. It is further contemplated that diameter d₁ may be in a range of approximately 1 mm to 35 mm.

First end 40 defines a substantially planar face 44 that engages a planar face 46 of first end 24 of implant 12 in a substantially flush engagement. It is envisioned that faces 44, 46 may have alternative surface configurations for alternative fixation configurations therebetween, such as, for example, those alternatives described herein.

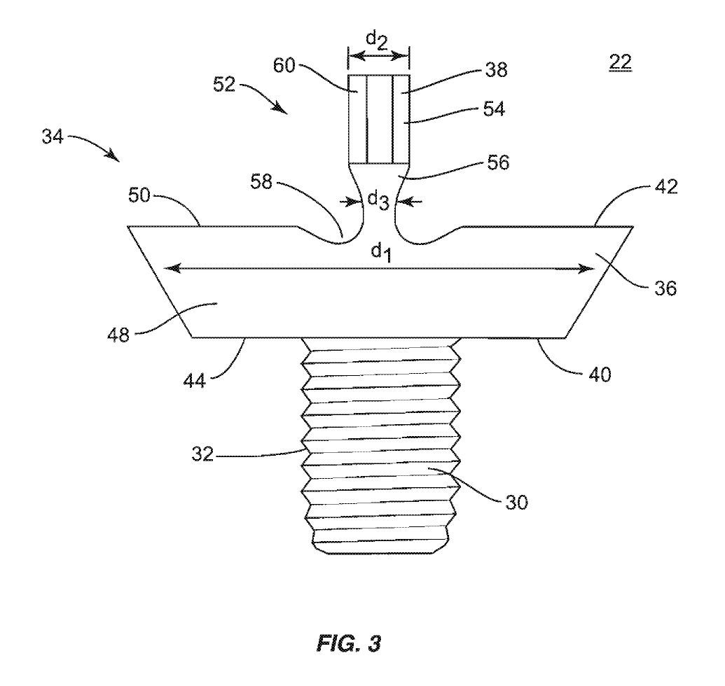

Base 36 has a cylindrical cross section configuration taken along a longitudinal axis of abutment 22 and a trapezoidal side cross section taken from a lateral view, as shown in FIG. 3. This geometric configuration of base 36 forms a frustro conical configuration that provides stability for engagement with dental implant 12 and adjacent tissue, as well as support of a dental prosthetic. It is contemplated that all or a portion of base 36 may be disposed below the gum line and/or within bone. It is also contemplated that all or a portion of base 36 may be disposed above the gum line. It is envisioned that the longitudinal and lateral cross sections of base 36 may have various configurations, such as, for example, those alternatives described herein. Base 36 defines an outer surface 48 that is substantially smooth and engageable with tissues adjacent the body cavity. It is contemplated that outer surface 48 may have alternate surface configurations such as, for example, those alternatives described herein.

Base 36 defines a surface, such as, for example, a platform 50 that is configured to support a dental prosthetic. Platform 50 is substantially planar to provide support and stability for a dental prosthetic. In one embodiment, all or a portion of the surface of base 36 has a non-planar configuration, such as, for example, arcuate, undulating, stepped, offset, concave, convex, conical and/or angled. It is envisioned that the surface of base 36 may be specifically configured for support and attachment of a dental prosthetic including prosthetic teeth, bridges or fixtures for dentures. It is further envisioned that the surface of base 36 can have alternate surface configurations such as, for example, smooth, textured, grooved, slotted, include openings, and/or include engagement elements such as square, trapezoidal or polygonal shaped risers, barbs, spikes and detents.

Second portion 34 includes a drive 52 including a first end 54 connected with second end 42 of base 36. First end 54 is connected with base 36 via a reduced diameter portion 56, which facilitates separation of drive 52 from abutment 22, for example, fracture by mechanical failure at a predetermined force, such as, for example, a predetermined torque. Drive 52 has a thickness, such as, for example, diameter d₂ adjacent first end 54. Diameter d₂ is configured such that first end 54 is engageable with an implement, such as, for example, a tool described below, which facilitates mounting of abutment 22 with dental implant 12. It is contemplated that diameter d₂ may be in a range of approximately 0.05 mm to 10.00 mm.

The thickness or diameter of drive 52 is tapered and decreases to a second thickness, such as, for example, a diameter d₃. Platform 50 includes an annular recess 58 that further defines diameter d₃. It is contemplated that diameter d₃ may be in a range of approximately 0.01 mm to 3.00 mm.

Diameter d₃ has reduced thickness and/or reduced diameter portion 56 is fabricated from a fracturing and/or frangible material adjacent annular recess 58 in a configuration such that drive 52 can fracture and separate from second end 42 at a predetermined torque limit according to the requirements of a particular application. It is contemplated that reduced diameter portion 56 may be fabricated from materials such as those described herein in a fracturing and/or frangible configuration. It is further contemplated that drive 52 can fracture and separate from abutment 22 at a predetermined force or torque limit, which may be in a range of approximately 20 Newton centimeters (N-cm) to 35 N-cm, although other ranges are envisioned.

It is contemplated that first end 54 and reduced diameter portion 56 may have the same or alternate cross section configurations, such as, for example, those alternative configurations described herein. It is further contemplated that abutment 22 may be fabricated from a homogenous material or heterogeneously fabricated such that various portions of abutment 22 are formed from different materials, for example, reduced diameter portion 56 can be formed of a material having a greater degree, characteristic or attribute of plastic deformability, frangible property and/or break away quality to facilitate fracture and separation of drive 52 from abutment 22.

In use, in a procedure subsequent to embedding dental implant 12 within the body cavity of the jaw, as described below, a tool (not shown) is employed that includes a socket configured to mate with facing elements 60 of first end 54. Upon alignment of abutment 22 with implant 12 along a longitudinal axis a of dental implant system 10, the socket mates with first end 54 to rotate, for example, in a clockwise direction, shaft 30 into threaded fixation with surface 16 within cavity 20. It is envisioned that each of the components of dental implant system 10 may define its own axis which may be co-axial, offset, transverse or orthogonal to longitudinal axis a.

The socket is caused to apply a predetermined torque, for example, in the range described above, which is a predetermined force limit for fixing abutment 22 with implant 12 such that surface 32 is rotated into fixation with surface 16. The tool continues to apply torque to dental implant system 10 via engagement with first and end 54 and rotates drive 52 causing increased resistance due to engagement and fixation of the surfaces of the components of dental implant system 10, and the resistance of implanted dental implant 12.

As torque is applied and resistance increases, the predetermined torque and force limit is approached. The socket rotates drive 52 until the predetermined torque limit is reached whereby, reduced diameter portion 56 is caused to fracture and separate from base 36. This configuration facilitates fixation and securement of abutment 22 with dental implant 12 at a selected and maximum torque such that drive 52 automatically breaks away at the predetermined force limit, according to the requirements of a particular application and without using a torque measurement tool. It is envisioned that drive 52 may be configured to break away at a range of torque levels, such as, for example, those torque limits described herein.

Dental implant system 10 includes a dental prosthetic, such as, for example, a crown 62. Crown 62 is configured for mounting with platform 50 of base 36. Upon separation and fracture of drive 52 from abutment 22, described above, crown 62 is disposed in alignment with longitudinal axis a adjacent abutment 22. It is envisioned that crown 62 may be oriented co-axial, offset, angularly offset or transverse to longitudinal axis a. Crown 62 includes base surfaces 64 that engage platform 50 for fixed support therewith. It is envisioned that surfaces 64 and/or platform 50 may include alternate surface configurations for alternative fixation configurations to enhance fixation therebetween, such as, for example, those alternate configurations described herein. Crown 62 defines an inner cavity 66 that receives abutment 22.

It is contemplated that dental implant system 10 may include one or a plurality of abutments 22 for use with variously sized implants, or include healing abutments and/or temporary abutments. In one embodiment, dental implant system 10 may be packaged as a system or kit. It is envisioned that the system or kit may include an abutment and a prosthetic for fixation with a pre-implanted dental implant. It is further envisioned that the system or kit may include an abutment, a prosthetic, a dental implant and bone graft material for use therewith. Variously configured prosthetic(s) may also be included in the system or kit. The components of dental implant system 10 can be made of radiolucent materials such as polymers. Radiomarkers may be included for identification under x-ray, fluoroscopy, CT or other imaging techniques.

In one embodiment, one or all of the components of dental implant system 10 may include voids and/or openings, for including therapeutic polynucleotides or polypeptides and bone growth promoting material, which can be packed or otherwise disposed therein. For example, such voids and/or openings may include at least one agent including biocompatible materials, such as, for example, biocompatible metals and/or rigid polymers, such as, titanium elements, metal powders of titanium or titanium compositions, sterile bone materials, such as allograft or xenograft materials, synthetic bone materials such as coral and calcium compositions, such as hydroxyapatite, calcium phosphate and calcium sulfite, biologically active agents, for example, biologically active agents coated onto the exterior of one or all of the components of implant repair system 10 and/or applied thereto for gradual release such as by blending in a bioresorbable polymer that releases the biologically active agent or agents in an appropriate time dependent fashion as the polymer degrades within the patient. Suitable biologically active agents include, for example, BMP and cytokines.

One or all of the components of dental implant system 10 may include one or a plurality of agent reservoirs. The agent reservoirs can be configured as drug depots with medication for pain and may include antibiotics and/or therapeutics. It is envisioned that the agent reservoirs contain active agents and may include one or a plurality of therapeutic agents and/or pharmacological agents for release, including sustained release, to treat, for example, pain, inflammation and degeneration. The agents may include pharmacological agents, such as, for example, antibiotics, anti-inflammatory drugs including but not limited to steroids, anti-viral and anti-retroviral compounds, therapeutic proteins or peptides, therapeutic nucleic acids (as naked plasmid or a component of an integrating or non-integrating gene therapy vector system), and combinations thereof.

The agent may also include analgesics or anesthetics such as acetic acid derivatives, COX-2 selective inhibitors, COX-2 inhibitors, enolic acid derivatives, propionic acid derivatives, salicylic acid derivatives, opioids, opioid/nonopioid combination products, adjuvant analgesics, and general and regional/local anesthetics.

The agent may also include antibiotics such as, for example, amoxicillin, beta-lactamases, aminoglycosides, beta-lactam (glycopeptide), clindamycin, chloramphenicol, cephalosporins, ciprofloxacin, erythromycin, fluoroquinolones, macrolides, metronidazole, penicillins, quinolones, rapamycin, rifampin, streptomycin, sulfonamide, tetracyclines, trimethoprim, trimethoprim-sulfamthoxazole, and vancomycin.

The agent may also include immunosuppressives agents, such as, for example, steroids, cyclosporine, cyclosporine analogs, cyclophosphamide, methylprednisone, prednisone, azathioprine, FK-506, 15-deoxyspergualin, prednisolone, methotrexate, thalidomide, methoxsalen, rapamycin, leflunomide, mizoribine (Bredinin™), brequinar, deoxyspergualin, and azaspirane (SKF 105685), Orthoclone OKT™ 3 (muromonab-CD3). Sandimmune™, Neoral™, Sangdya™ (cyclosporine), Prograf™ (FK506, tacrolimus), Cellcept™ (mycophenolate motefil, of which the active metabolite is mycophenolic acid), Imuran™ (azathioprine), glucocorticosteroids, adrenocortical steroids such as Deltasone™ (prednisone) and Hydeltrasol™ (prednisolone), Folex™ and Mexate™ (methotrxate), Oxsoralen-Ultra™ (methoxsalen) and Rapamuen™ (sirolimus).

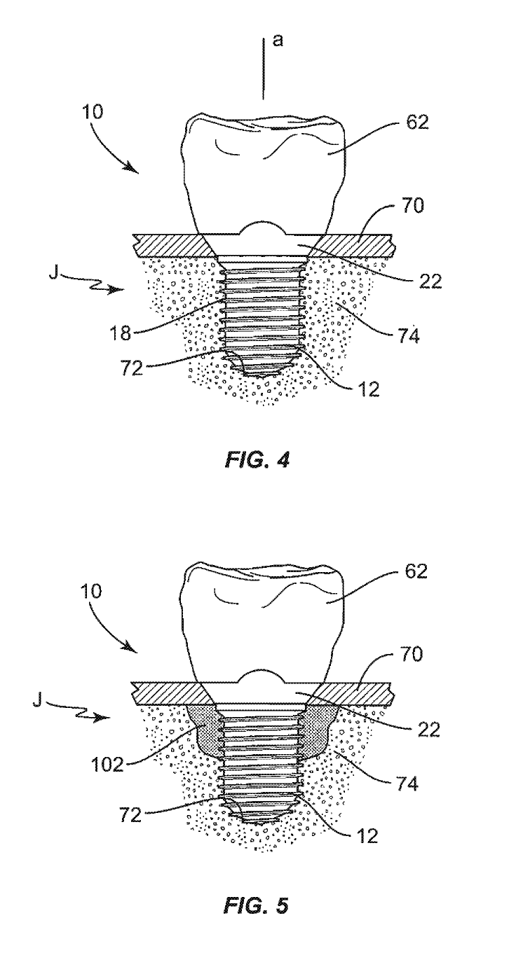

Referring to FIG. 4, in assembly, operation and use, dental implant system 10, which may include one or more of the components described above, is employed with one or more procedures, such as, for example, those including a surgical jaw restoration that includes a first implantation procedure for implanting a dental implant and a second, subsequent procedure for mounting an abutment and a prosthetic, for treating periodontal disorders. Dental implant 12, similar to that described above, is provided for implantation within a jaw of a patient. Dental implant system 10 is employed to restore a portion of jaw J. It is contemplated that the components of dental implant system 10 can be employed for a surgical jaw restoration in a single procedure that includes simultaneous or concurrent implantation of a dental implant and, securement and fixation of component surfaces such as the surfaces of an abutment and a prosthetic.

In the first implantation procedure, gingival soft tissue 70 is retracted from an implant region at a surgical site to expose a body cavity of a jaw J, such as, for example, a cavity 72 disposed in gingival soft tissue 70 and bone 74 of the jaw J. Cavity 72 is mechanically debrided with an instrument (not shown) to remove tissue from surfaces of jaw J adjacent cavity 72 including granulation, tissue and bone matter. The tissue surfaces of jaw J adjacent cavity 72 at the surgical site are cleaned.

Dental implant 12 is inserted with body cavity 72 such that outer surface 18 engages with tissue 70 and/or bone 74 adjacent cavity 72 below the gum line of jaw J of the implant region at the surgical site. Dental implant 12 is embedded within body cavity 72 of jaw J for implantation thereof. Cavity 72 is disposed circumferentially about dental implant 12. It is contemplated that dental implant 12 implanted within body cavity 72 is allowed to heal such that bone growth contacts and anchors dental implant 12 within jaw J prior to mounting of abutment 22 with dental implant 12. It is further contemplated that dental implant 12 may include a temporary cap.

In the second, subsequent procedure, shaft 30 (FIG. 3) of abutment 22 is inserted with cavity 20 and outer surface 32 is brought into engagement with surface 16. A tool (not shown) is manipulated by the practitioner to mate with first end 54, as described above. Upon alignment of abutment 22 with implant 12 along longitudinal axis a, the practitioner rotates shaft 30 with the tool into threaded fixation with surface 16 within cavity 20. The tool is caused to apply a force up to a predetermined torque for fixing abutment 22 with implant 12 such that surface 32 is rotated into securement and fixation with surface 16. The tool continues to apply torque to dental implant system 10 via engagement with first end 54 and rotates drive 52 causing increased resistance due to engagement and fixation of the surfaces of the components of dental implant system 10, and the resistance of implanted dental implant 12.

The socket rotates drive 52 until the predetermined torque limit is reached such that reduced diameter portion 56 is caused to fracture and separate from base 36. This configuration facilitates securement and fixation of abutment 22 with dental implant 12 at a selected and maximum torque such that drive 52 automatically breaks away at the predetermined force limit without using a torque measurement tool. Upon separation and fracture of drive 52 from abutment 22, crown 62 is disposed in alignment with longitudinal axis a adjacent abutment 22. Crown 62 is manipulated for mounting and fixed support with abutment 22.

In one embodiment, as shown in FIG. 5, dental implant system 10, similar to that described with regard to FIG. 4, includes bone graft 102, similar to the bone graft described above. Prior, simultaneous and/or subsequent to implantation of the components of dental implant system 10 with cavity 72, bone graft 102 is injected, disposed, packed and/or layered within, on or about the components and/or surfaces of dental implant system 10 and/or within cavity 72. Bone graft 102 surrounds and is circumferentially disposed about dental implant 12 to establish integration and form new bone in jaw J adjacent the implant region at the surgical site.

It will be understood that various modifications may be made to the embodiments disclosed herein. Therefore, the above description should not be construed as limiting, but merely as exemplification of the various embodiments. Those skilled in the art will envision other modifications within the scope and spirit of the claims appended hereto.

1. A dental implant system comprising:
an abutment including a first portion configured for disposal within an inner cavity of a dental implant and defining an outer surface configured for fixation with an inner surface of the dental implant, the abutment further including
a base having a first end and a second end and a gradually decreasing diameter from the second end to the first end, the base includes a surface defining a platform being configured to engage a prosthetic implant; and
a drive including a first end having a diameter and a reduced diameter portion, the drive being configured for connection to a tool and the reduced diameter portion being connected with the base and configured to fracture and separate from the base at a predetermined torque prior to attachment of the prosthetic implant, wherein the diameter of the first end is larger then the reduced diameter.

2. A dental implant system according to claim 1, wherein the drive is configured to separate by mechanical failure at a predetermined force limit.

3. A dental implant system according to claim 1, wherein the drive is configured to separate and fracture from the second portion at the predetermined force, which is a torque in a range between 20 N-cm and 35 N-cm.

4. A dental implant system according to claim 1, wherein the drive defines a reduced thickness configured to separate by mechanical failure at a predetermined force limit.

5. A dental implant system according to claim 1, wherein the drive defines a first end and a reduced diameter portion configured to separate and fracture from the second portion of the abutment at the predetermined force.

6. A dental implant system according to claim 1, further comprising a dental prosthetic configured for mounting with the abutment.

7. A dental implant system according to claim 1, further comprising a tool mateable with the drive to apply at least the predetermined force including a predetermined torque for fixing the abutment with the dental implant, the drive being further configured to separate and fracture from the second portion of the abutment at the predetermined force including the predetermined torque.

8. A dental implant system according to claim 7, wherein the tool includes a socket that mates with a plurality of facing elements of the drive.

9. A dental implant system according to claim 1, wherein the second portion includes a base disposed between the first portion and the drive.

10. (canceled)

11. (canceled)

12. (canceled)

13. A dental implant system comprising:
a dental implant being positionable within a body cavity disposed below an outer surface of a jaw, the dental implant including a first end, an inner surface that defines an inner cavity and an outer surface configured for fixation with the body cavity; and
an abutment comprising:
a shaft defining an outer surface configured for disposal within the inner cavity of the dental implant and configured for fixation with the inner surface of the dental implant;
a base having a first end and a tapered diameter from the first end to the shaft, the first end having a includes a surface defining a platform being configured to engage a prosthetic implant; and
a drive including a first end having a diameter and a reduced diameter portion, the first end configured for connection to a tool and the reduced diameter portion being connected with the base and configured to fracture and separate from the base at a predetermined torque prior to attachment of the prosthetic implant, wherein the diameter of the first end is larger then the reduced diameter portion.

14. (canceled)

15. A dental implant system according to claim 13, further comprising a tool including a socket mateable with the first end to apply the predetermined torque.

16. (canceled)

17. A dental implant system according to claim 16, wherein the platform defines an annular recess disposed about the reduced diameter portion.

18. A method for treating a jawbone, the method comprising the steps of:
providing an abutment including a first portion defining an outer surface configured for disposal within an inner cavity of a dental implant disposed within a body cavity of the jawbone and configured for fixation with an inner surface of the dental implant, the abutment further including a second portion having a drive configured to separate from the abutment at a predetermined force;
inserting the first portion of the abutment with the dental implant; and
engaging the drive with a force to fix the abutment with the dental implant to the predetermined force such that the drive separates from the abutment at the predetermined force prior to attachment of a prosthetic implant.

19. A method of implanting a dental implant according to claim 18, further comprising the steps of inserting a dental implant with the body cavity of the jawbone and securing the dental implant to bone of the jawbone.

20. A method of implanting a dental implant according to claim 18, further comprising a step of mounting a dental prosthetic with a platform of the abutment.
